(19) United States
(12) Patent Application Publication
(10) Pub. No.: US 2025/0121307 A1
(43) Pub. Date: Apr. 17, 2025

(54) WATER PURIFIER

(71) Applicant: COWAY Co., Ltd., Gongju-si (KR)

(72) Inventors: Kyu Jun KIM, Gongju-si (KR); An Ho CHO, Gongju-si (KR); Jong Hwan LEE, Gongju-si (KR); Hee Do JUNG, Gongju-si (KR); Hee Joo KANG, Gongju-si (KR); Byung Hyo YE, Gongju-si (KR); Sang Woo BANG, Gongju-si (KR)

(73) Assignee: COWAY Co., Ltd., Gongju-si (KR)

(21) Appl. No.: 18/827,345

(22) Filed: Sep. 6, 2024

(30) Foreign Application Priority Data
Oct. 11, 2023 (KR) 10-2023-0134959

(51) Int. Cl. B01D 35/30; F25C 1/25

(52) U.S. Cl. CPC B01D 35/303; B01D 2201/30; B01D 2201/31; F25C 1/25

(57) ABSTRACT

The water purifier according to an aspect of the present invention may include a housing; a first module unit configured to generate purified water or ice; a second module unit connected to the first module unit to discharge purified water or ice to the outside; and a front panel unit having a size and shape capable of covering the opening of the housing and coupled to the housing to be opened and closed through linear or rotational motion to conceal the opening in a closed state and to expose the opening in an open state.

### CROSS-REFERENCE TO RELATED APPLICATION

This application claims priority to and the benefit of Korean Patent Application No. 10-2023-0134959, filed on Oct. 11, 2023, the disclosure of which is incorporated herein by reference in its entirety.

### TECHNICAL FIELD

The present invention relates to a water purifier, and more particularly, to a water purifier with improved user convenience.

### BACKGROUND OF THE INVENTION

A water purifier is an apparatus for providing purified water by purifying raw water supplied from the outside, and recently, water purifiers that generate and provide ice using purified water in addition to providing purified water, such as the “ice purifier” of Korean Patent Laid-Open Publication No. 10-2023-0027691, have been widely used.

Such a water purifier has a structure that includes internal components such as a filter module, a purified water generation module, and an ice generation module inside the housing, and an extraction module for discharging purified water or ice generated by connecting these modules through a flow path to the outside according to the user's selection.

In this case, the extraction module may include a purified water outlet for discharging purified water and an ice outlet for discharging ice, and is placed on the front side of the water purifier for the user's convenience and is configured to discharge purified water or ice downward.

Meanwhile, water purifiers require regular cleaning or replacement of parts to prevent bacteria or microorganisms from inhabiting components and space in the spaces that come in contact with purified water or ice.

For such cleaning or replacement work, the water purifier has a detachable side plate or upper plate of the housing, and the housing can be separated to perform cleaning or replacement work.

Meanwhile, in the case of an outlet located in front of the water purifier that discharges purified water or ice, there is a high possibility that foreign substances will flow inside due to water splashing during use by the user, so a shorter cleaning cycle is required.

Typically, in order to block the inflow of foreign substances into the water purifier and facilitate cleaning, the outlet is connected to detachable parts (e.g., ice dispenser guide, detachable flow path, faucet guide, etc.), and is configured so that they can be separated and cleaned during washing.

However, conventional water purifiers had no choice but to separate the upper plate or side plate of the housing for cleaning or replacing these parts, or to remove detachable parts of the water purifier downward and then clean them.

Meanwhile, parts that had been cleaned or replaced had to be re-engaged, but due to the work through the lower side of the water purifier, the field of view was not properly secured, so the user performing cleaning or replacement work had no choice but to work while checking with his head down.

Due to this hassle, the user was forced to neglect cleaning the front side of the water purifier, that is, the outlet side, and as a result, the possibility of bacteria or microorganisms inhabiting the water purifier increased.

In order to solve this problem, there is an urgent need to develop a water purifier having a structure in which a user may easily perform cleaning and replacement of front components including an outlet of the water purifier.

### SUMMARY OF THE INVENTION

### Technical Problem

The present invention is to solve the above problems, and the present invention is directed to providing a water purifier that increases ease of cleaning and replacement of parts and maximizes user convenience through selective opening of the front opening of the water purifier.

In addition, it is directed to providing a water purifier that allows users (consumers) to easily clean and replace exposed parts with a structure that can easily open the front opening of the water purifier by linearly moving or rotating a front panel unit.

In addition, it is directed to providing a water purifier that allows users to intuitively check a cleaning area and replacement parts of the water purifier through the open opening.

In addition, it is directed to providing a water purifier capable of minimizing interference between the water purifier and other structures in a space where the water purifier is installed with a structure that moves the front panel unit upward or downward.

The problems of the present invention are not limited to those mentioned above, and other problems not mentioned will be clearly understood by those of ordinary skill in the art from the following description.

### Technical Solution

According to an aspect of the present invention, a water purifier is provided.

The water purifier may include a housing having an internal space and an opening; a first module unit accommodated in the internal space of the housing and configured to generate purified water or ice; a second module unit accommodated in the internal space through the opening of the housing so as to be detachable from the housing in a first direction, at least partially exposed through the opening while coupled to the housing, and connected to the first module unit through a detachable flow path to discharge purified water or ice generated in the first module unit to the outside; and a front panel unit including at least one of a display unit and a manipulation unit, and having a size and shape capable of covering at least the opening of the housing and coupled to the housing to be opened and closed through linear or rotational motion to conceal the opening in a closed state and to expose the opening in an open state.

In this case, the front panel unit includes at least one hinge shaft part on one side thereof.

In addition, the housing includes a guide part having a length in the first direction accommodating the hinge shaft part and supporting a linear or rotational motion of the hinge shaft part.

Meanwhile, the housing may further include a support frame unit provided in the internal space of the housing to support the second module unit and including the guide part.

In addition, the hinge shaft part is provided on both sides of the front panel unit in a second direction.

In addition, the guide part includes a guide groove accommodating the hinge shaft part, and a guide rail forming an edge of the guide groove and guiding movement of the hinge shaft part, and is provided on both sides of the housing in the second direction corresponding to the hinge shaft part.

Meanwhile, the hinge shaft part may include an extension bar having a length corresponding to the guide groove; and a cylindrical rotation shaft protruding from an end of the extension bar in the second direction.

In addition, the guide groove may include a first groove formed at one end in the first direction and having a size and shape that can accommodate the rotation shaft; a second groove formed at the other end in the first direction and having a size and shape that can accommodate the rotation shaft; and a rail groove connecting the first groove and the second groove and supporting the rotation shaft to be movable between the first groove and the second groove.

If necessary, the hinge shaft part may further include a damping member that adjusts the rotational motion speed of the rotation shaft.

As an example, the damping member may be composed of an O-ring member fitted to the outer circumferential surface of the rotation shaft, and the second groove may be in contact with the outer circumferential surface of the O-ring member during rotation of the rotation shaft to generate friction.

Meanwhile, if necessary, the guide rail disposed in a third direction of the rail groove further has an opening hole of a size that allows the rotation shaft to be separated or coupled.

In addition, the first groove and the second groove further form a hill part on the inner surface of the guide rail connected to the rail groove.

Meanwhile, as an example, in the front panel unit, the hinge shaft part is formed on the lower side thereof in a third direction, and the hinge shaft part may be moved in a linear motion in the first direction along the guide part, and then the upper side in the third direction may be tilted downward and rotated around the hinge shaft part to expose the opening to the outside.

In addition, in the front panel unit, the hinge shaft part is formed on the upper side thereof in a third direction, and the hinge shaft part may be moved in a linear motion in the first direction along the guide part, and then the lower side in the third direction may be tilted upward and rotated around the hinge shaft part to expose the opening to the outside.

If necessary, the front panel unit may further include at least one hook coupling part detachably coupled to the housing on one side of an edge in the second direction or third direction.

In addition, the front panel unit may further include an inner cover having a size and shape capable of covering a surface facing the second module unit.

In addition, the housing may further include a splash prevention plate detachably coupled to the bottom surface of the front panel unit in a third direction.

### Advantageous Effects

According to the configuration, the water purifier according to the present invention can move the front panel unit through a linear motion or a rotational motion, thereby easily opening the front opening of the water purifier.

In addition, the user's convenience can be increased by allowing the user to easily perform cleaning and replacement work of the exposed second module unit through easy separation of the front panel unit disposed in front of the housing of the water purifier.

In addition, the user can intuitively check the cleaning area and the second module unit of the water purifier through the open opening of the housing, allowing the user to easily perform cleaning and replacement parts.

In addition, it is possible to minimize interference between the water purifier and other structures in a space where the water purifier is installed with a structure that moves the front panel unit upward or downward.

Advantageous effects of the present invention are not limited to the above-described effects, and should be understood to include all effects that can be inferred from the configuration of the invention described in the detailed description or claims of the present invention.

### BRIEF DESCRIPTION OF THE DRAWINGS

FIG. 1 is a perspective view showing a water purifier according to an exemplary embodiment of the present invention.

FIG. 2 is a schematic view showing the internal arrangement structure of a water purifier according to an exemplary embodiment of the present invention.

FIG. 3 is a view showing an embodiment of opening an opening by moving a front panel unit in a water purifier according to an exemplary embodiment of the present invention.

FIG. 4 is a view showing a hinge shaft part and a guide part for separating and moving a front panel unit by separating a side plate from a water purifier according to an exemplary embodiment of the present invention.

FIGS. 5 and 6 are views showing an example of a front panel unit applied to a water purifier according to an exemplary embodiment of the present invention.

FIGS. 7 and 8 are enlarged views showing a guide part provided in a support frame unit in a water purifier according to an exemplary embodiment of the present invention.

FIG. 9 is an enlarged view showing a coupled state of a hinge shaft part and a guide part by enlarging a portion A of FIG. 4.

FIG. 10 is a partial cross-sectional view showing a coupled and operation state of a hinge shaft part and a guide part applied to a water purifier according to an exemplary embodiment of the present invention.

FIG. 11 is a view showing an operation of linearly moving a front panel unit forward in a water purifier according to an exemplary embodiment of the present invention.

FIG. 12 is a view showing an operation of rotating a front panel unit downward in the water purifier of FIG. 11.

### DETAILED DESCRIPTION OF THE EMBODIMENTS

Hereinafter, exemplary embodiments of the present invention will be described in detail so that those of ordinary skill in the art can readily implement the present invention with reference to the accompanying drawings. The present invention may be embodied in many different forms and is not limited to the embodiments set forth herein. In the drawings, parts unrelated to the description are omitted for clarity of description of the present invention, and throughout the specification, same or similar reference numerals denote same elements.

Terms and words used in the present specification and claims should not be construed as limited to their usual or dictionary definition. They should be interpreted as meaning and concepts consistent with the technical idea of the present invention, based on the principle that inventors may appropriately define the terms and concepts to describe their invention in the best way.

Accordingly, the embodiments described in the present specification and the configurations shown in the drawings correspond to preferred embodiments of the present invention, and do not represent all the technical idea of the present invention, so the configurations may have various examples of equivalent and modification that can replace them at the time of filing the present invention.

It should be understood that the terms “comprise” or “have” or the like when used in this specification, are intended to describe the presence of stated features, integers, steps, operations, elements, components and/or a combination thereof but not preclude the possibility of the presence or addition of one or more other features, integers, steps, operations, elements, components, or a combination thereof.

The presence of an element in/on “front”, “rear”, “upper or above or top” or “lower or below or bottom” of another element includes not only being disposed in/on “front”, “rear”, “upper or above or top” or “lower or below or bottom” directly in contact with other elements, but also cases in which another element being disposed in the middle, unless otherwise specified. In addition, unless otherwise specified, that an element is “connected” to another element includes not only direct connection to each other but also indirect connection to each other.

The terms “X-axis,” “Y-axis,” and “Z-axis” used in the description will be understood with reference to the coordinate system shown in the drawings. In addition, the description refers to the X-axis direction as the first direction, the Y-axis direction as the second direction, and the Z-axis direction as the third direction, but this is only one example according to a relative perspective, and the first to third directions and coordinate axes (X, Y, Z axes) are introduced to explain the relative positions between components and do not limit the absolute positions of each component.

Additionally, in describing the present invention, detailed descriptions of related known functions or configurations will be omitted in order to not obscure the gist of the present invention.

Hereinafter, a water purifier according to an exemplary embodiment of the present invention will be described with reference to the accompanying drawings.

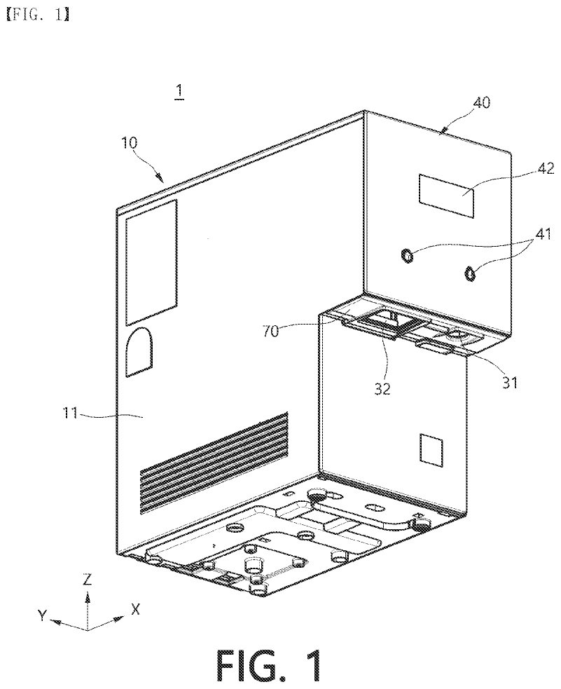

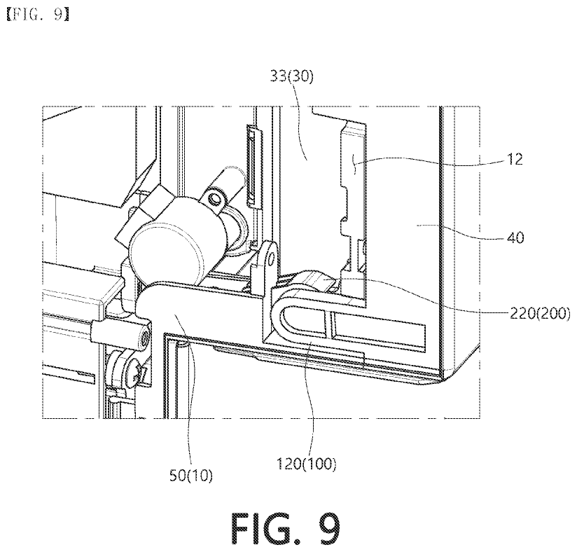

As shown in FIGS. 1 to 12, the water purifier 1 according to an exemplary embodiment of the present invention is configured to open a front opening 12 of the water purifier 1 by moving and separating a front panel unit 40 placed on the front side of the water purifier 1 through linear or rotational motion.

In this way, module components disposed on the front side of the water purifier 1 are exposed through the open opening 12, and the user can easily separate the exposed components through the open opening 12 to perform cleaning or component replacement work.

In other words, the water purifier 1 according to an exemplary embodiment of the present invention is characterized by moving the front panel unit 40 provided on the front side of the water purifier 1 to expose the opening 12, and then easily separate and clean or replace hidden internal components as the opening 12 is exposed.

In a more specific embodiment, to this end, the water purifier 1 according to an exemplary embodiment of the present invention largely includes a housing 10, a first module unit 20, a second module unit 30, and a front panel unit 40.

First, the housing 10 determines the size of the water purifier 1, and includes plates (cases) surrounding the outside (up, down, left, and right), including a side plate 11 and an upper plate 14, and has a box shape equipped with an internal space S so that each component, including individual components or modular components, is arranged so that they do not interfere with each other.

Specifically, in the internal space S of the housing 10, a first module unit 20 including a filter module 21, a purified water generation module 22 for generating purified water (where ‘purified water’ may be any one of purified water at room temperature, purified water at high temperature, or purified water at low temperature), and an ice generation module 23 for generating ice is provided, and purified water or ice is generated through the first module unit 20.

In addition, the second module unit 30 is detachably connected to the first module unit 20 described above to the front side of the housing 10 through a detachable flow path 13, and discharges purified water or ice generated in the first module unit 20 to the outside according to the user's selection.

This second module unit 30 includes a purified water outlet 31 for discharging purified water to the lower side of the water purifier 1 and an ice outlet 32 for discharging ice, and has a structure capable of discharging purified water or ice to the outside.

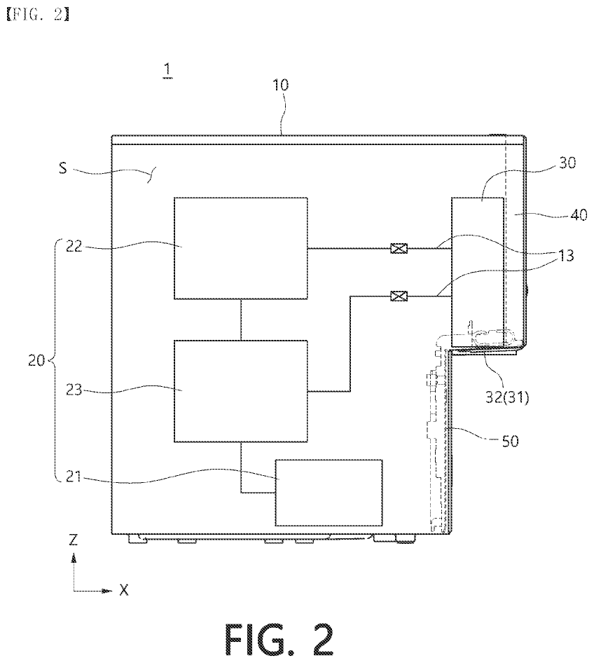

Meanwhile, the second module unit 30 is accommodated in the internal space S through the opening 12 of the housing 10 to be detachable forward from the housing 10, that is, in the first direction, and at least a part of it is exposed through the opening 12 while coupled to the housing 10. In addition, it is connected to the first module unit 20 through the detachable flow path 13 (FIG. 2) so that purified water or ice generated in the first module unit 20 may be discharged to the outside.

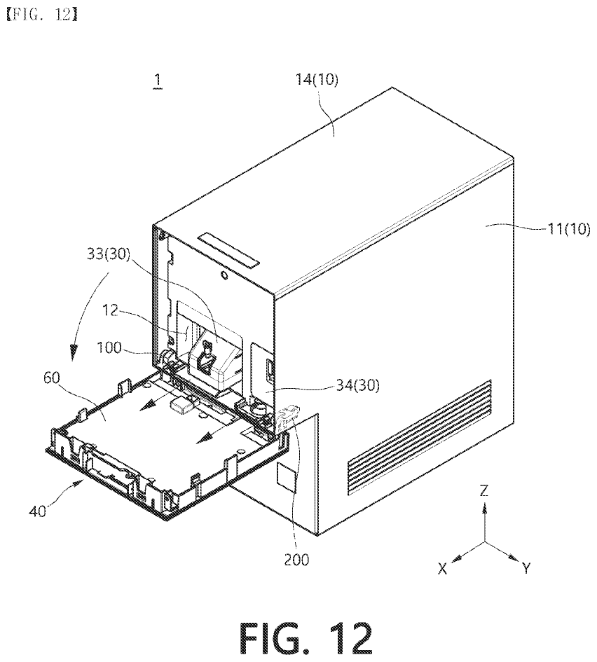

In this case, the second module unit 30 may include an ice dispenser guide 33 and a detachable flow path module 34 (see FIG. 12) in order to smoothly supply purified water or ice and block intrusion of foreign substances.

Meanwhile, if necessary, the housing 10 may include a support frame unit 50 supporting the first module unit 20 or the second module unit 30 described above in the internal space S.

The support frame unit 50 may more stably support internal components including the first module unit 20 and the second module unit 30 described above and prevent damage by external force.

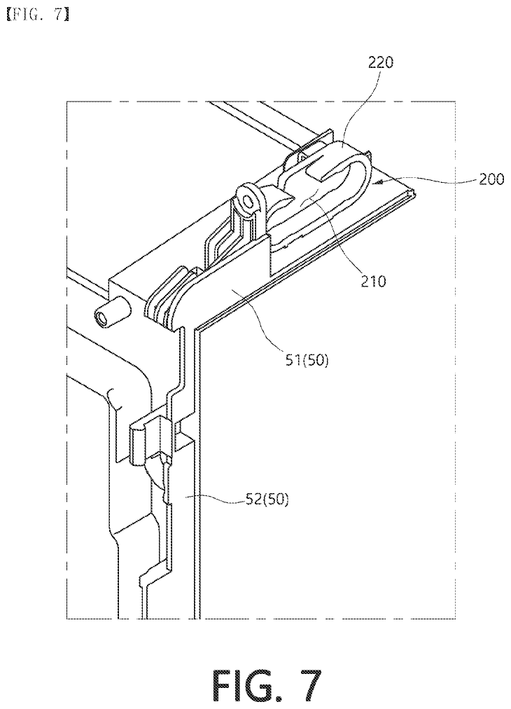

To this end, the support frame unit 50 may have a structure including a horizontal frame 51 including a purified water outlet 31 and an ice outlet 32 of the second module unit 30, and a vertical frame 52 covering and supporting the lower front surface of the housing 10 (see FIG. 7).

Meanwhile, the front panel unit 40 is placed on the front side of the housing 10 in the first direction to hide and conceal the opening 12 forming the front surface of the housing 10 described above.

The front panel unit 40 may include a manipulation unit 101 and a display unit 42 so that the user may select purified water or ice supply, and may include internal electrical components for electrical operation.

In other words, the front panel unit 40 applied to the water purifier 1 according to an exemplary embodiment of the present invention has a size and shape that can cover at least the opening 12 of the housing 10, and is coupled to selectively open and close the opening 12 through linear or rotational motion with respect to the housing 10.

Accordingly, the front panel unit 40 has a size and shape capable of concealing the opening 12 of the housing 10 in a closed state and exposing the opening 12 of the housing 10 in an open state.

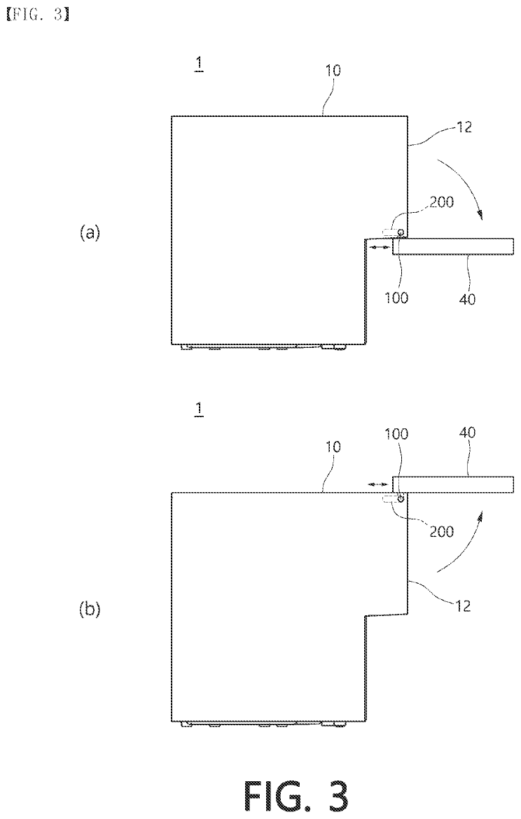

As an example for opening the opening 12 of the housing 10, the front panel unit 40 may be moved linearly in the first direction, and then, as shown in FIG. 3(a), the upper side of the front panel unit 40 in the third direction may be rotated while being tilted downward to expose the opening 12.

As another example, the front panel unit 40 may be moved linearly in the first direction, and then, as shown in FIG. 3(b), the lower side of the front panel unit 40 in the third direction may be rotated while being tilted upward to expose the opening 12.

In this case, the water purifier 1 according to an exemplary embodiment of the present invention has a structure that can move the front panel unit 40 upward or downward rather than moving it in both sides of the housing 10, that is, in the second direction, so that interference with the water purifier 1 and other structures (e.g., microwave oven, wall, etc.) is minimized in the space where the water purifier 1 is installed.

Accordingly, the user may easily perform cleaning and component replacement work through the open opening 12.

Meanwhile, in order to facilitate opening of the opening 12 through the movement of the front panel unit 40, the water purifier 1 according to an exemplary embodiment of the present invention includes a hinge shaft part 100 and a guide part 200.

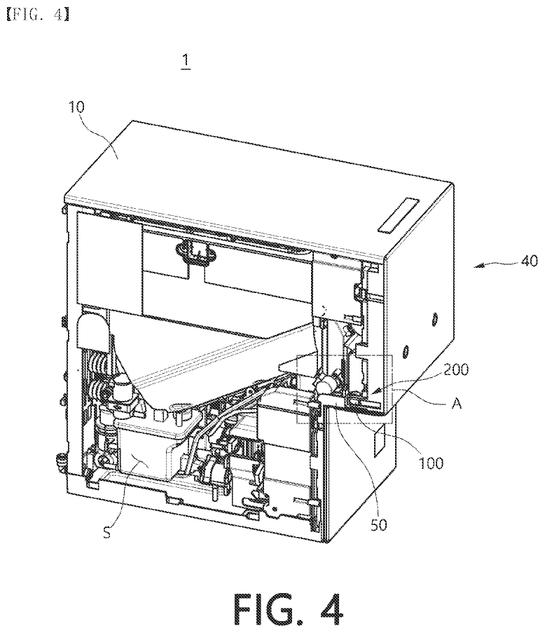

Specifically, referring again to FIGS. 4 to 10, the water purifier 1 according to an exemplary embodiment of the present invention includes at least one hinge shaft part 100 on one side of the front panel unit 40

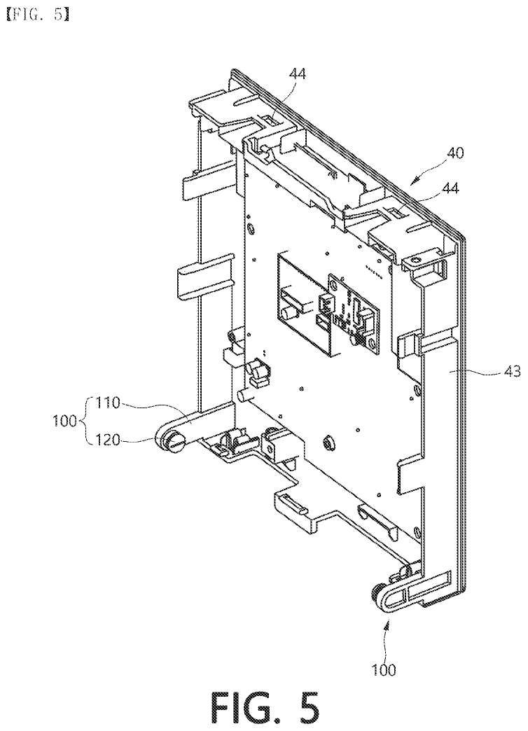

In this case, preferably, the hinge shaft part 100 is provided on both sides in the second direction of the panel frame 43 (FIG. 5) constituting the front panel unit 40.

The hinge shaft part 100 may be provided on the lower side of the front panel unit 40 in an embodiment such as FIG. 3(a), and may be provided on the upper side of the front panel unit 40 in an embodiment such as FIG. 3(b).

In addition, the housing 10 includes a guide part 200 that has a length in the first direction and supports the linear or rotational motion of the hinge shaft part 100 while accommodating the hinge shaft part 100 of the front panel unit 40.

In this case, the guide part 200 may be provided in the internal space as a component of the housing 10 and may be formed in a support frame unit 50 that protects and supports the first module unit 20 or the second module unit 30.

In the drawing, it is shown that the guide part 200 is formed in the support frame unit 50 of the housing 10, and through this, the configuration of the hinge shaft part 100 and the guide part 200 will be described in more detail.

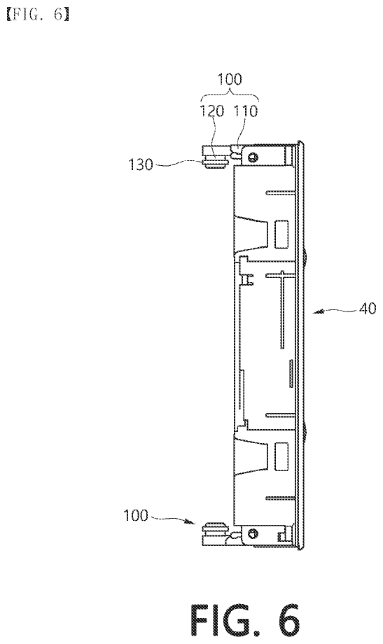

First, referring to FIGS. 5 and 6, the hinge shaft part 100 is provided, for example, on both sides of the front panel unit 40 in the second direction.

In this case, the hinge shaft part 100 includes an extension bar 110 having a length in the first direction with respect to the panel frame 43.

And, at an end of the extension bar 110, a cylindrical rotation shaft 120 protruding inside the panel frame 43 in the second direction is provided.

In this case, the rotation shaft 120 has a size and shape that can be accommodated and rotated in a first groove 211 and a second groove 212 of the guide part 200 to be described later.

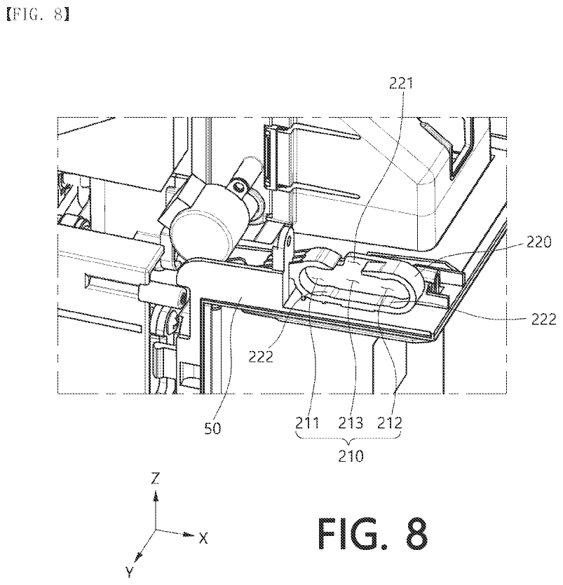

Meanwhile, referring to FIGS. 7 and 8, the guide part 200 is provided on both sides in the second direction of the support frame unit 50 of the housing 10 to correspond to the hinge shaft part 100 described above.

In this case, the guide part 200 has a length in the first direction and is configured to accommodate the above-described hinge shaft part 100 and support the linear or rotational motion of the hinge shaft part 100.

In more detail, the guide part 200 includes a guide groove 210 in which the above-described rotation shaft 120 of the hinge shaft part 100 is accommodated, and a guide rail 220 that forms the edge of the guide groove 210 and guides the linear or rotational motion of the hinge shaft part 100.

Specifically, the guide groove 210 of the guide part 200 includes a first groove 211 formed at one end in the first direction and having a size and shape to accommodate the rotation shaft 120 of the hinge shaft part 100, and a second groove 212 formed at the other end in the first direction and having a size and shape to accommodate the rotation shaft 120 of the hinge shaft part 100.

In addition, the guide groove 210 serves as a passage connecting the first groove 211 and the second groove 212 described above, and includes a rail groove 213 that supports the above-described rotation shaft 120 to be movable between the first groove 211 and the second groove 212. The rail groove 213 has a set length in the first direction.

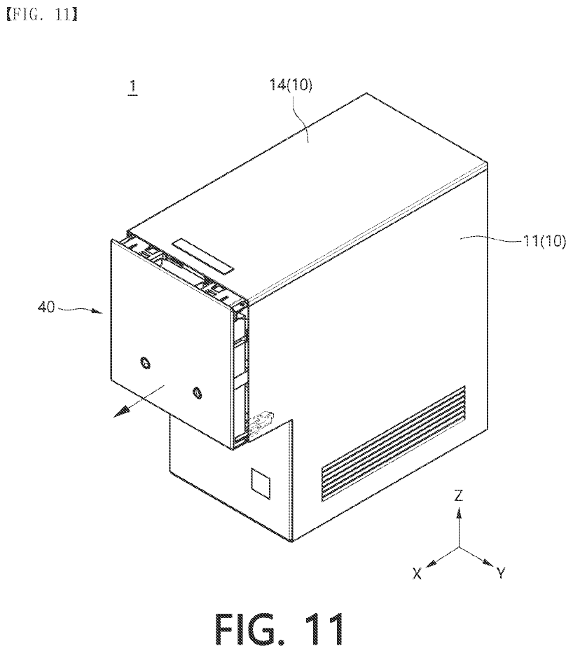

According to the configuration of the hinge shaft part 100 and the guide part 200, the user may move the front panel unit 40 by linearly moving it in the first direction by the interval between the first groove 211 and the second groove 212 of the guide part 200 described above, and may position the hinge shaft part 100 in the second groove 212 and then move it by rotating it upward or downward in the third direction (see FIGS. 11 and 12).

In addition, if necessary, the hinge shaft part 100 of the front panel unit 40 may be moved straight from the second groove 212 to the first groove 211 again so that the front panel unit 40 may be supported by the housing 10 stably without shaking (see FIG. 3(b)).

According to the movement of the linear motion or rotational motion of the front panel unit 40, the opening 12 of the housing 10 is exposed in the first direction.

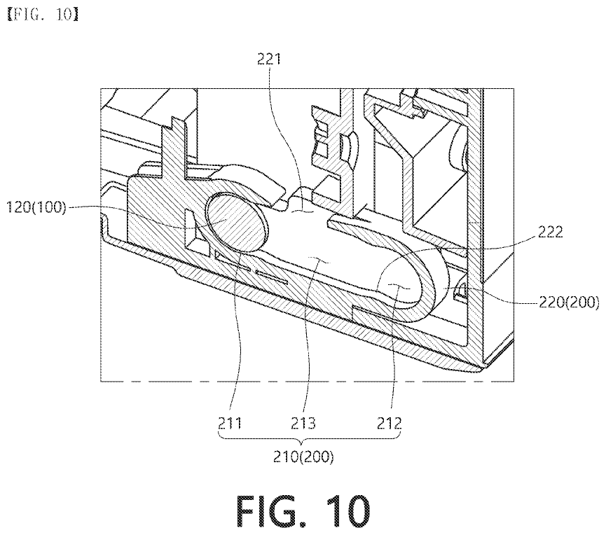

Meanwhile, the first groove 211 and the second groove 212 of the guide part 200 described above further form a hill part 222 on the inner surface of the guide rail 220 as a part connected to the above-described rail groove 213 (see FIGS. 8 and 10).

The hill part 222 serves as a step and may prevent the rotation shaft 120 from arbitrarily moving in the first direction along the guide groove 210.

Meanwhile, the front panel unit 40 may include at least one hook coupling part 44 (FIG. 5) detachably coupled to the housing 10 on one side of the edge of the panel frame 43 in the second direction or third direction so as not to be arbitrarily separated from the housing 10 when the opening 12 is closed as shown in FIG. 1.

Since various known structures may be applied to the coupling and release of the hook coupling part 44, a detailed structure and description thereof will be omitted in order not to obscure the gist of the present invention.

Meanwhile, referring again to FIG. 6, the hinge shaft part 100 applied to the water purifier 1 of the present invention includes a damping member 130 to adjust the speed during rotation.

In other words, a damping member (130) is provided to prevent damage to the front panel unit 40 due to an impact generated by the rotation of the front panel unit 40 at a high speed by its own weight during the rotational motion of the front panel unit 40, and to adjust the rotational speed of the hinge shaft part 100 to prevent safety accidents such as a user's hand getting caught between the front panel unit 40 and the housing 10.

For example, this damping member 130 may be composed of an O-ring member fitted to the outer circumferential surface of the rotation shaft 120.

In addition, the second groove 212 of the guide part 200, located in the front in the first direction, generates friction while contacting the outer circumferential surface of the O-ring member, which is the damping member 130, during the rotational motion of the rotation shaft 120 described above.

Accordingly, when the rotational motion of the front panel unit 40 is a rotational motion in which the upper side of the third direction is tilted downward around the hinge shaft part 100, as shown in FIG. 12, the speed is adjusted by the frictional force formed by the O-ring member, which is the damping member 130, and the second groove 212, so that the front panel unit 40 can rotate slowly, thereby increasing safety.

Meanwhile, as described above, the front panel unit 40 includes a manipulation unit 41 and a display unit 42 for user operation, and these electrical components need to be prevented from contact with moisture as much as possible.

To this end, as shown in FIG. 12, the front panel unit 40 further includes an inner cover 60 having a size and shape capable of covering the surface facing the second module unit 30 at the opening 12 inward.

This inner cover 60 covers and blocks an area equipped with electrical components in the front panel unit 40, and fundamentally blocks electrical failure of electrical components due to moisture when the user cleans or replaces exposed parts of the second module unit 30 after opening the opening 12.

Meanwhile, as shown in FIG. 12, the exposed upper surface of the inner cover 60 described above may also be used as an object pedestal, thereby enhancing user convenience during cleaning or replacement work.

Meanwhile, in the water purifier 1 according to an exemplary embodiment of the present invention, the front panel unit 40 may be completely separated from the housing 10.

To this end, the guide part 200 further forms an opening hole 221 at one side of the guide rail 220 in a size through which the rotation shaft 120 of the hinge shaft part 100 may escape (see FIG. 8).

Preferably, the opening hole 221 is formed in a position that does not interfere with other components provided in the opening 12 of the housing 10.

As an example, the opening hole 221 is formed in the guide rail 220 disposed in the third direction of the rail groove 213 forming the guide groove 210. Additionally, the opening hole 221 has a size that allows the rotation shaft 120 of the hinge shaft part 100 to be separated or coupled in the third direction.

Accordingly, the rotation shaft 120 of the hinge shaft part 100 is optionally separated from and coupled to the guide part 200 through the opening hole 221, and optionally, the user may completely separate the front panel unit 40 from the housing 10 for cleaning and replacement work as needed.

In this case, electrical components for electrical operation of the front panel unit 40 may be electrically connected or disconnected through a detachable connector.

Meanwhile, the water purifier 1 according to an exemplary embodiment of the present invention further includes a splash prevention plate 70 to prevent water from splashing upward and facilitate cleaning when the front panel unit 40 closes the opening 12 of the housing 10, that is, when the user is in a state where the water purifier is available.

In other words, the housing 10 further includes a splash prevention plate 70 detachably coupled to the bottom surface of the front panel unit 40 in the third direction, and when performing cleaning and replacement work, the above-described splash prevention plate 70 is first separated and then cleaning and replacement work is performed.

Meanwhile, of course, in order to facilitate the exposure of the opening 12 of the housing 10, the upper plate 14 of the housing 10 may be separated first, and then the front panel unit 40 may be linearly moved or rotated.

In addition, although not shown, if necessary, of course, one side of the front panel unit 40 may be provided with a protrusion (not shown) that serves as a handle that the user can easily hold and apply force for easy linear or rotational motion of the front panel unit 40.

As described above, in the water purifier 1 according to an exemplary embodiment of the present invention, it is possible to easily open the front opening 12 of the water purifier 1 can be easily opened by linearly moving or rotating the front panel unit 40 through the hinge shaft part 100 and the guide part 200.

The user's convenience may be increased by allowing the user to easily perform cleaning and replacement work of the exposed second module unit 30 through easy separation and movement of the front panel unit 40 disposed in front of the housing 10 of the water purifier 1.

In addition, the user can intuitively check the cleaning area and replacement parts of the water purifier 1 through the open opening 12 of the housing 10, allowing the user to easily perform cleaning and replacement parts.

In addition, the structure of moving the front panel unit 40 upward or downward can minimize interference between the water purifier and other structures in the space where the water purifier 1 is installed.

Although exemplary embodiments of the present invention have been described, the idea of the present invention is not limited to the embodiments set forth herein. Those of ordinary skill in the art who understand the idea of the present invention may easily propose other embodiments through supplement, change, removal, addition, etc. of elements within the same idea, but the embodiments will be also within the idea scope of the present invention.

1. A water purifier, comprising:
a housing having an internal space and an opening;
a first module unit accommodated in the internal space of the housing and configured to generate purified water or ice;
a second module unit accommodated in the internal space through the opening of the housing so as to be detachable from the housing in a first direction, at least partially exposed through the opening while coupled to the housing, and connected to the first module unit through a detachable flow path to discharge purified water or ice generated in the first module unit to the outside; and
a front panel unit including at least one of a display unit and a manipulation unit, and having a size and shape capable of covering at least the opening of the housing and coupled to the housing to be opened and closed through linear or rotational motion to conceal the opening in a closed state and to expose the opening in an open state.

2. The water purifier of claim 1,
wherein the front panel unit comprises at least one hinge shaft part on one side thereof, and
wherein the housing comprises:
a guide part having a length in the first direction, accommodating the hinge shaft part and supporting a linear or rotational motion of the hinge shaft part.

3. The water purifier of claim 2, wherein the housing further comprises a support frame unit provided in the internal space of the housing to support the second module unit and having the guide part.

4. The water purifier of claim 2,
wherein the hinge shaft part is provided on both sides of the front panel unit in a second direction, and
wherein the guide part comprises a guide groove accommodating the hinge shaft part, and a guide rail forming an edge of the guide groove and guiding movement of the hinge shaft part, and is provided on both sides of the housing in the second direction corresponding to the hinge shaft part.

5. The water purifier of claim 4,
wherein the hinge shaft part comprises:
an extension bar having a length corresponding to the guide groove; and
a cylindrical rotation shaft protruding from an end of the extension bar in the second direction.

6. The water purifier of claim 5,
wherein the guide groove comprises:
a first groove formed at one end in the first direction and having a size and shape that can accommodate the rotation shaft;
a second groove formed at the other end in the first direction and having a size and shape that can accommodate the rotation shaft; and
a rail groove connecting the first groove and the second groove and supporting the rotation shaft to be movable between the first groove and the second groove.

7. The water purifier of claim 6, wherein the hinge shaft part further comprises a damping member that adjusts the rotational motion speed of the rotation shaft.

8. The water purifier of claim 7,
wherein the damping member is composed of an O-ring member fitted to the outer circumferential surface of the rotation shaft, and
wherein the second groove is in contact with the outer circumferential surface of the O-ring member during rotation of the rotation shaft to generate friction.

9. The water purifier of claim 6, wherein the guide rail disposed in a third direction of the rail groove further has an opening hole of a size that allows the rotation shaft to be separated or coupled.

10. The water purifier of claim 6, wherein the first groove and the second groove further form a hill part on the inner surface of the guide rail connected to the rail groove.

11. The water purifier of claim 2,
wherein in the front panel unit,
the hinge shaft part is formed on the lower side thereof in a third direction, and
the hinge shaft part is moved in a linear motion in the first direction along the guide part, and then
the upper side in the third direction is tilted downward and rotated around the hinge shaft part to expose the opening to the outside.

12. The water purifier of claim 2,
wherein in the front panel unit,
the hinge shaft part is formed on the upper side thereof in a third direction, and
the hinge shaft part is moved in a linear motion in the first direction along the guide part, and then
the lower side in the third direction is tilted upward and rotated around the hinge shaft part to expose the opening to the outside.

13. The water purifier of claim 11, wherein the front panel unit further comprises at least one hook coupling part detachably coupled to the housing on one side of an edge in the second direction or third direction.

14. The water purifier of claim 11, wherein the front panel unit further comprises an inner cover having a size and shape capable of covering a surface facing the second module unit.

15. The water purifier of claim 1, wherein the housing further comprises a splash prevention plate detachably coupled to the bottom surface of the front panel unit in a third direction.

16. The water purifier of claim 12, wherein the front panel unit further comprises at least one hook coupling part detachably coupled to the housing on one side of an edge in the second direction or third direction.
